(19) United States
(12) Patent Application Publication
(10) Pub. No.: US 2006/0144306 A1
(43) Pub. Date: Jul. 6, 2006

(54) Method for converting tire rubber to coke

(76) Inventor: George Montgomery, Rose Hill, VA (US)

Correspondence Address: George Montgomery, Route 2, Box 384-A, Rose Hill, VA, 24281, US

(21) Appl. No.: 11/028,266

(22) Filed: Jan. 3, 2005

(51) Int. Cl. F23B 7/00; B01J 2/00

(52) U.S. Cl. 110/341; 110/230

(57) ABSTRACT

A method for converting tire rubber to coke comprising, in combination, the steps of: blending a quantity of tire rubber and a quantity of chemical change agents and motor oil to form a homogeneous mixture; baking the homogeneous mixture in a reducing environment for a corresponding duration of time to form a coke product; and cooling the resultant coke product.

### BACKGROUND OF THE INVENTION

### Field of the Invention

The present invention relates to converting used or waste tires to a coke product by driving off the volatile matter contained in the tire rubber.

### History Related to Disposal of Used or Waste Tires

Disposing of huge stockpiles of used and waste tires has long been an annoying problem for governmental entities and environmental organizations. Stockpiles of waste tires are estimated to be in the billions of tires and present significant environmental concerns. In getting a solution for disposing of waste tires, scientists and engineers have been continuously studying recovery of organic wastes such as waste tires. There are many ways to dispose of waste tires. Landfills have been one means of disposal; however, due to the limitation of the resource of land, landfills are not suitable. Other means of tire disposal include incineration, use in civil engineering projects such as road construction and use in making recycled tires.

In this respect, the conversion and coking methods for used or waste tires set forth herein substantially departs from known concepts of disposing of used or waste tires by converting them to a coke product by driving off the volatile matter contained in the tire rubber.

### SUMMARY OF THE INVENTION

In view of the disadvantages inherent in the known types of methods of converting used or waste tires, the present invention provides an improved conversion and coking method and product.

To attain this the present invention essentially comprises a conversion and coking method for converting used or waste tires to a coke product, which results in a clean burning fuel which can be used by utilities and in other industrial applications, by driving off the volatile matter contained in the tire rubber, comprising in combination, the steps of:

1. providing a quantity of ground tire rubber;

2. providing a quantity of chemical change agents selected from the class of chemical change agents including: (a) sodium silicate (b) National 33-9012 starch, commercially available from the National Starch and Chemical Company (c) National 13-2216 starch, commercially available from the National Starch and Chemical Company.

3. mixing the chemical change agents with motor oil in preparation for spraying on the ground tire rubber;

4. blending or mixing the provided quantity of ground tire rubber and chemical change agent and motor oil such that there is a substantial and general and complete coverage of the tire rubber;

5. baking the blended mixture in a reducing, heated, oxygen-free environment, including a heating element, at a temperature ranging from 1,400-1,850 degrees Fahrenheit for a period of time of about 3 to 4 hours; and

6. cooling the resultant baked product by exposing such product to air or a water quench. In addition, the present invention also includes the resultant coke product.

There has thus been outlined, rather broadly, the more important features of the invention in order that the detailed description thereofthat follows may be better understood. There are additional features of the invention that will be described hereinafter and which will form the subject matter of the claims attached.

In this respect, before explaining at least one embodiment of the invention in detail, it is to be understood that the invention is not limited in its application to the details of construction and to the arrangements of the component steps set forth in the following description. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is another object of the present invention to provide a means of converting used or waste tires to a coke product which may be easily and efficiently manufactured and marketed.

An even further object of the present invention is to provide a method for converting used or waste tires to an energy product which is susceptible of a low cost of manufacture with regard to both materials and labor, and which accordingly is then susceptible of low prices of sale, thereby making such conversion method and product economical.

Even still another object of the present invention is to provide a coking method and product for converting used or waste tires to a coke product by driving off the volatile matter contained in the tire rubber.

It is an object of the present invention to provide a new and improved method for converting used or waste tires to coke comprising, in combination, the steps of blending or mixing a quantity of ground up used or waste tires and a quantity chemical change agents with motor oil such that there is a substantial and general and complete coverage of the material; baking the mixture in a reducing environment for a corresponding duration of time to form a coke product; and cooling the resultant coke product.

Finally, it is another object of the present invention to provide municipalities and environmental organizations with an economically feasible solution to disposing of used or waste tires.

These together with other objects of the invention, along with the various features of novelty which characterized the invention, are pointed out with particularity in the claims annexed to and forming a part of this disclosure. For a better understanding of the invention, its operating advantages and the specific objects attained by its uses, reference should be had to the accompanying descriptive matter in which there is described the preferred embodiments of the invention.

### DESCRIPTION OF THE PREFERRED EMBODIMENT

The present invention, the conversion and coking method and product is comprised of several components. Such components in their broadest context include blending or mixing the components, heating the blended components and cooling the heated components.

More specifically, the present invention is a conversion and coking method for converting used or waste tires to a coke product, a clean burning fuel which may be used by utilities and other industrial applications. The conversion is done by driving off the volatile matter contained in the tire rubber.

The first step is to obtain a quantity of ground tire rubber. Although the process would work on non ground rubber, having the rubber ground into pieces makes it easier to apply and obtain a coverage of the tire rubber with chemical change agent and motor oil as further explained in the foregoing steps.

The next step is providing a quantity of chemical change agent. Such agent is selected from the class of chemical change agents including: (a) sodium silicate (b) National 33-9012 starch, commercially available from the National Starch and Chemical Company (c) National 13-2216 starch, commercially available from the National Starch and Chemical Company. It should be noted that other chemicals containing sodium will also make the reaction work in varying degrees.

The quantity of the chemical change agent to be used also varies depending on the factors of 1) the quantity of tire rubber which is to be converted and 2) the chemical change agent chosen to perform the conversion. The greater the quantity of rubber to be converted, the more chemical change agent that will be needed to perform the conversion. Generally, it takes three (3) times as much starch to perform the reaction as sodium silicate.

Next is the step of mixing the chemical change agents with motor oil in preparation for blending or mixing with the ground tire rubber. While motor oil is suggested because it will enhance the baking process, other oils would also serve to allow the reaction to occur. The quantity of the motor oil to be used would also vary depending on the quantity of tire rubber to be converted. The mixing should be done to obtain a substantial and general and complete coverage of the ground tire rubber.

Thereafter, the method includes the step of blending or mixing the provided quantity of ground tire rubber and chemical agent. Such blending is preferably in a ratio of about 1 ton of ground tire rubber plus or minus ten percent, about 25 gallons of oil plus or minus ten percent, and about ½ gallon to 4 gallons of sodium silicate plus or minus ten percent or 1½ gallons to 12 gallons of starch plus or minus ten percent to obtain a substantial and general coverage of the material.

The next step is then baking the mixture in a reducing, heated, oxygen-free environment, including a heating element, at a temperature of about 1,400 to 1,850 degrees Fahrenheit for a period of time of 3 to 4 hours.

Lastly is the step of cooling the resultant baked product by air or with a water quench.

The invention also includes the coke product formed by the method as described herein above. There are various typical examples of the method steps of the present invention.

### EXAMPLE 1

A mixture was formed with the following ingredients

16 cups (approximately ten (10) pounds) of ground tire rubber, and

a mixture of 2 ounces of sodium silicate and ½ gallon of motor oil as required to obtain a substantial and general and complete coverage of the ground tire rubber.

The mixture was heated in a reducing environment for approximately 3 to 4 hours at 1,400 degrees Fahrenheit then air cooled. The resulting product was porous coke having the following analysis:

| | |
|---|---|
| Ash | 14% |
| Sulfur | 1.3% |
| BTU/pound | 12,700 BTU |

### EXAMPLE 2

Step 1. A mixture was formed with the following ingredients

16 cups (approximately ten (10) pounds) of ground tire rubber, and

a mixture of 6 ounces of National 33-9012 starch and ½ gallon of motor oil as required to obtain a substantial coverage of the ground tire rubber.

The mixture was heated in a reducing environment for approximately 3 to 4 hours at 1,400 degrees Fahrenheit then air cooled. The resulting product was porous coke having the following analysis:

| | |
|---|---|
| Ash | 14% |
| Sulfur | 1.3% |
| BTU/pound | 12,700 BTU |

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A method of converting used or waste tires to a coke product by driving off the volatile matter contained in the tire rubber which results in a clean burning fuel which may be used by utilities and other industrial applications, comprising in combination, the steps of:.
a. providing a quantity of ground tire rubber;
b. providing a quantity of chemical change agents selected from the class of chemical change agents including: (a) sodium silicate (b) National 33-9012 starch, commercially available from the National Starch and Chemical Company (c) National 13-2216 starch, commercially available from the National Starch and Chemical Company.
c. mixing the chemical change agents with motor oil in preparation for spraying on the ground tire rubber;
d. blending or mixing the provided quantity of ground tire rubber and chemical change agent and motor oil such that there is a substantial and general and complete coverage of the tire rubber;
e. baking the blended mixture in a reducing, heated, oxygen-free environment, including a heating element, at a temperature ranging from 1,400 to 1,850 degrees Fahrenheit, for a period of time of about 3 to 4 hours; and
f. cooling the resultant baked product by exposing such product to the air or to a water quench.

2. A method of converting used or waste tires to coke comprising, in combination, the steps of: (a) blending a quantity of tire rubber and a quantity of chemical agent mixed in motor oil until there is a substantial and general and complete coverage of the tire rubber; (b) baking the mixture in a reducing environment for a 3 to 4 hours at a temperature ranging from 1,400 to 1,850 degrees to form a coke product; and (c) cooling the resultant coke product.

3. The method set forth wherein the chemical change agents are selected from the class of chemical change agents including (a) sodium silicate (b) National 33-9012 starch, commercially available from the National Starch and Chemical Company (c) National 13-2216 starch, commercially available from the National Starch and Chemical Company.

4. The method set forth that other chemicals containing sodium as well as pure sodium will also allow the reaction to occur in varying degrees.

5. The method set forth wherein a quantity of chemical agent is mixed with motor oil in preparation for spraying on the tire rubber;

6. The method set forth wherein the mixture of chemical agent and motor oil is mixed with the tire rubber until there is a substantial and general and complete coverage of the tire rubber.

7. The method set forth wherein the blended mixture is baked in a reducing, heated, oxygen-free environment, including a heating element, at a quantity of temperatures ranging as low as between about 1,400 degrees Fahrenheit and as high as about 1,850 degrees Fahrenheit;

8. The method set forth wherein the blended mixture is baked in a reducing, heated, oxygen-free environment, including a heating element, for a period of time as short as 3 hours and as long as 4 hours.

9. The system as set forth wherein the cooling is done in air;

10. The system set forth wherein the cooling is done in water;

11. A coke product comprising: (a) a blend of a quantity of tire rubber and a quantity of chemical change agents and motor oil to form a mixture; (b) the mixture being baked in a reducing, heated, oxygen-free environment for a corresponding duration of time to form a coke product; and (c) the baked mixture being cooled by air or water to form the resultant coke product.
